(19) United States
(12) Patent Application Publication
(10) Pub. No.: US 2021/0057709 A1
(43) Pub. Date: Feb. 25, 2021

(54) SYSTEM LAYOUT FOR A MODULAR BATTERY SYSTEM

(71) Applicant: STACKTRONIC INC., Kitchener (CA)

(72) Inventors: Riley STONE, Courtice (CA); Ethan HAMSHAW, Calgary (CA); Nicolas BENAIS-THOMSON, Toronto (CA); Keith TEEPLE, Burlington (CA)

(21) Appl. No.: 17/000,186

(22) Filed: Aug. 21, 2020

Related U.S. Application Data
(60) Provisional application No. 62/890,845, filed on Aug. 23, 2019.

(51) Int. Cl. H01M 2/20; H01M 2/10

(52) U.S. Cl. CPC H01M 2/206; H01M 2220/20; H01M 2/1077

(57) ABSTRACT

A modular battery system is provided that includes two primary components: a master module and multiple battery modules. The master module has two or more master terminals. The battery modules each have two subordinate negative terminals and two subordinate positive terminals. Two of the battery modules are electrically connected with a first electrical connection between the subordinate terminals on each module. Two or more of the subordinate terminals are electrically connected to the master terminals with a second electrical connection. One or both of the first electrical connection and the second electrical connection includes a parallel connection between two terminals of like polarity.

This application claims the benefit of U.S. provisional application entitled SYSTEM LAYOUT FOR A MODULAR BATTERY SYSTEM having Ser. No. 62/890,845 by Stacktronic Inc., filed Aug. 23, 2019 and incorporated by reference herein.

### FIELD

The present invention is directed to batteries, and more specifically, a system layout for a modular battery system.

### BACKGROUND

Every year, vehicles emit millions of tons of greenhouse gas emissions, including carbon dioxide. Mass electrification of vehicles is required to reduce global carbon dioxide emissions but just a small percentage of vehicles produced in recent years have been electric-powered. Electrification could be particularly valuable in industrial contexts. For example, in the mining industry, costly ventilation systems are required to eliminate emissions from diesel-powered vehicles. If electric vehicles were more frequently employed in mines, mining entities could significantly reduce ventilation costs.

### SUMMARY

It is an aspect of the present disclosure to provide a modular battery system.

The above aspect can be attained by a system with two primary components: a master module and multiple battery modules. The master module has two or more master terminals. The battery modules each have two subordinate negative terminals and two subordinate positive terminals. The battery modules are electrically connected with a first electrical connection between the subordinate terminals on each module. Two or more of the subordinate terminals are electrically connected to the master terminals with a second electrical connection. One or both of the first electrical connection and the second electrical connection includes a parallel connection between two terminals of like polarity.

It is another aspect of the disclosure to provide a method for connecting batteries in a modular battery system. The method entails electrically connecting subordinate terminals on two battery modules of the plurality of interconnected battery modules with a first electrical connection. The method further entails electrically connecting one or more subordinate terminals on the battery modules to master terminals on a master module with a second electrical connection. One or both of the first electrical connection and the second electrical connection includes a parallel connection between two terminals of like polarity.

These together with other aspects and advantages, which will be subsequently apparent, reside in the details of construction and operation as more fully hereinafter described and claimed, reference being had to the accompanying drawings forming a part hereof, wherein like numerals and/or terminology refer to like parts throughout.

### BRIEF DESCRIPTION OF THE DRAWINGS

FIG. 1A is a schematic diagram of a prior art 2-terminal modular battery system.

FIG. 1B is a circuit diagram of the prior art 2-terminal modular battery system of FIG. 1A.

FIG. 2A is a schematic diagram of another configuration of the prior art 2-terminal modular battery system including a master module with four terminals.

FIG. 2B is a circuit diagram of the configuration of FIG. 2A.

FIG. 3A is a schematic diagram of a different configuration the prior art 2-terminal modular battery system with battery modules connected in both series and parallel.

FIG. 3B is a circuit diagram of the prior art 2-terminal modular battery system of FIG. 3A.

FIG. 4A is a schematic diagram of a 4-terminal modular battery system according to the present disclosure.

FIG. 4B is a circuit diagram of the 4-terminal modular battery system of FIG. 4A.

FIG. 5A is a schematic diagram of a two (2) series and four (4) parallel configuration of the 4-terminal modular battery system.

FIG. 5B is a circuit diagram of the configuration of FIG. 5A.

FIG. 6A is a schematic diagram of a single series and four (4) parallel pack configuration of the 4-terminal modular battery system.

FIG. 6B is a circuit diagram of the configuration of FIG. 6A.

FIG. 7A is a schematic diagram of a four (4) series and two (2) parallel configuration of the 4-terminal modular battery system.

FIG. 7B is a circuit diagram of the configuration of FIG. 7A.

FIG. 8A is a schematic diagram of a different four (4) series and two (2) parallel configuration of the 4-terminal modular battery system.

FIG. 8B is a circuit diagram of the configuration of FIG. 8A.

FIG. 9 is a perspective view of a battery module.

FIG. 10 is a perspective view of four interconnected battery modules.

### DETAILED DESCRIPTION

A battery pack is the primary source of energy from which fully electric vehicles draw to power their traction systems and other vehicle components. A battery pack is made up of interconnected battery “cells”, of which the form factor and chemistry can vary to suit the application requirements. The battery cells are joined in series, to form a multiple of the cell's individual voltage, and/or in parallel, to form a multiple of the cell's individual capacity and maximum, or highest, current draw.

Often cells are connected in series “strings” which may be seen as a group of cells where only series connections and no parallel connections are made. These series strings are linked in parallel to other series strings by each string's positive and negative terminals to form the final battery pack. A disadvantage of this design is that a fault in a single cell may electrically disconnect an entire series string, reducing the overall pack capacity and maximum current draw and in some cases, requiring the pack to function at reduced functionality or cease functioning altogether. In the latter case, the entire pack is removed from the vehicle and transported to a servicing location, while the vehicle is given a replacement pack.

To counter this reliability risk, battery packs where significant quantities of cells are electrically connected together are typically organized into battery “modules”. These modules may contain series and/or parallel connections between cells, the cumulative electrical output of which is connected to terminals on the module's exterior to be connected in series or parallel to other modules of the same or similar design. The benefit to modularization of the battery pack is that a module can be replaced in a faster, simpler, and safer way than doing the same procedure at a pack-level.

Battery modules typically include two terminals, one (1) positive terminal and one (1) negative terminal. Depending on the requirement of the battery pack, battery modules are connected in series or parallel through connections to these two terminals. The final electrical output, including one positive terminal on one module and one negative terminal on a separate or the same module, is typically connected to matching terminals on a “master module”, which is a module that typically contains relevant electronics but no battery cells and that interfaces with the vehicle powertrain.

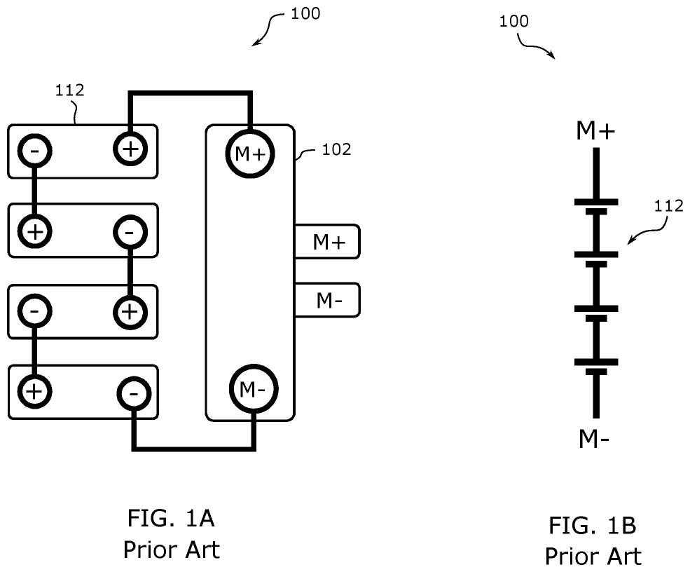

Turning to FIGS. 1A and 1B, two diagrams depict a prior art modular battery system 100. The system 100 includes four (4) battery modules 112 connected in series and connected cumulatively to a master module 102. In this pack there are no parallel connections. This connection configuration results in a pack that outputs four (4) times the voltage of a single battery module but has the capacity and current draw limitations of a single battery module.

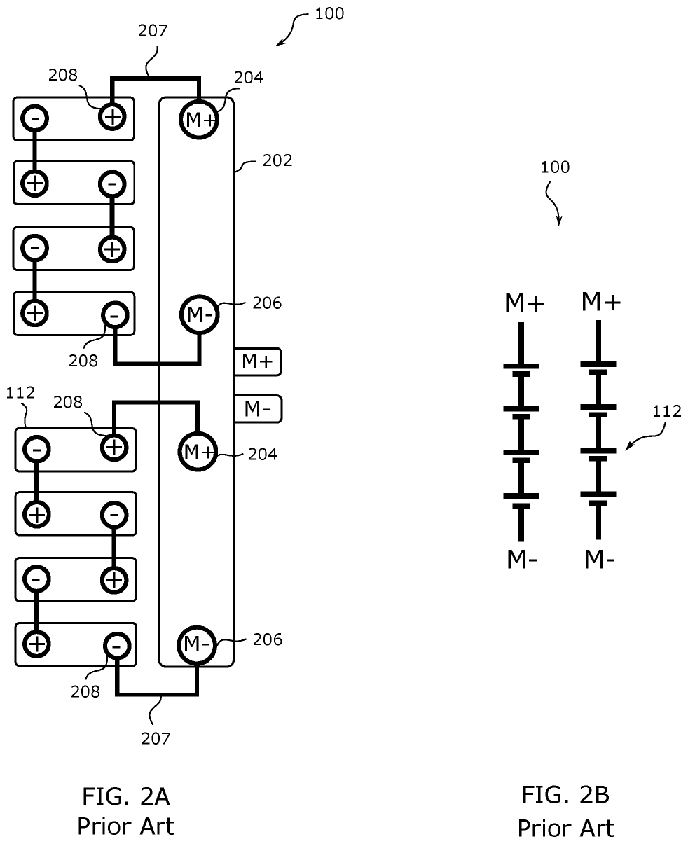

Turning to FIGS. 2A and 2B, a schematic and a circuit diagram show a different configuration of the prior art modular battery system 100. In this configuration, a master module 202 having two positive master terminals 204 and two negative master terminals 206 is depicted. Two (2) groups of battery modules 112 are shown connected in parallel, where each group includes four (4) battery modules 112 connected in series. This connection configuration results in a pack that outputs four (4) times the voltage of single module and possesses two (2) times the capacity and power output limitations of a single module.

An important aspect of battery pack architecture is the presence and location of parallel connections between modules within the pack. As the battery pack discharges current, small errors in battery cell, battery module, and battery pack manufacturing and assembly will cause the voltage of the modules to vary relative to one another over time. Due to this, for battery packs where two or more parallel branches exist, it is beneficial to pack runtime if each module is connected directly in parallel to at least one other module. In FIGS. 2A and 2B, the only parallel connections 207 made are between the terminals 208 of each series string of modules to the master's terminals 204, 206.

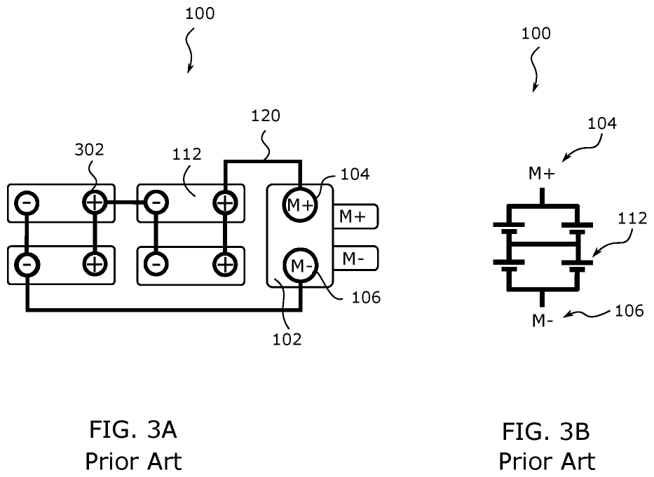

Turning to FIGS. 3A and B, a schematic and a circuit diagram depict a different configuration of the prior art modular battery system 100. In this configuration, four (4) battery modules 112 are connected both in series and in parallel to create a two (2) series, two (2) parallel pack. If each module 112 is connected in parallel to at least one other module, the voltage across the terminals of each module will remain equal to any modules connected in parallel to it. This prevents a single module from decreasing in voltage to the minimum module voltage limit significantly earlier than other modules in parallel to it, optimizing battery pack runtime. This connection configuration requires that any module, including the master module, supports the ability for one (1) terminal 302 to form two (2) separate connections. This requirement increases design complexity of connectors and for this reason, this single-terminal-multi-connection configuration is not often seen in high power applications where connector complexity is already high.

The addition of two (2), or more, terminals on a battery module to bring the total terminal count equal to four (4), or more, may be beneficial to permit simultaneous module series and parallel connections, enabling continuous voltage balancing between modules to optimize or improve battery pack runtime.

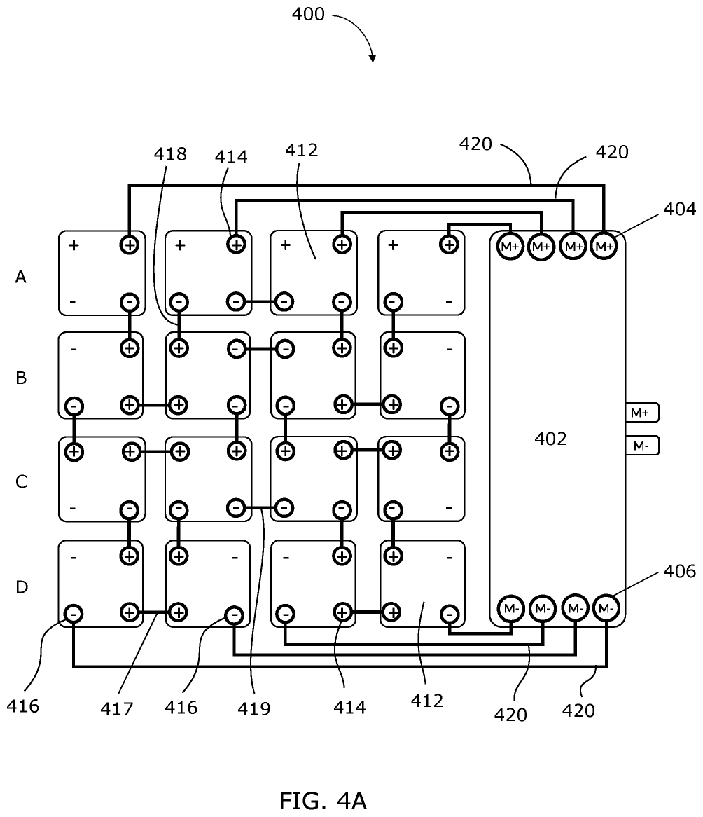

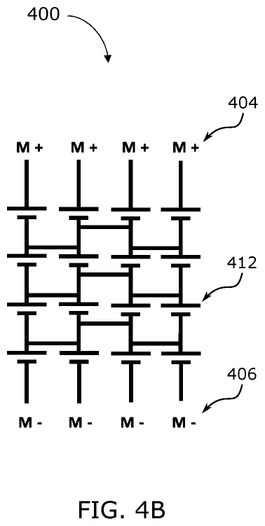

Turning to FIGS. 4A and 4B, a schematic and a circuit diagram depict an example of the 4-terminal modular battery system 400. The system 400 includes a master module 402 that has four (4) positive master terminals 404 and four (4) negative master terminals 406. The master module 402 may include any suitable number of positive and negative master terminals. Four of each are shown in the current embodiment for explanation purposes. The master module 402 may be a power distribution unit (PDU) or any apparatus that distributes electricity.

The system 400 further includes a set of modular batteries 412 that are connected in series and in parallel with each other. Again, although FIGS. 4A and 4B show a set of sixteen (16) battery modules 412, any suitable number of modular batteries may be selected. For illustrative purposes, the battery modules are aligned in four horizontal rows: row A, row B, row C, and row D, as indicated in FIG. 4A. Each modular battery has four terminals: two positive terminals 414 and two negative terminals 416.

A first electrical connection 417, 418, 419 may connect two battery modules 412. The two battery modules 412 may be adjacent, meaning there are no other battery modules between the two battery modules that are connected with the first electrical connection 417, 418, 419. In the current embodiment, the battery modules 412 in rows B and C are not connected to the master module 402 but are connected to adjacent battery modules 412 in rows A, B, C, and D. Some of the first electrical connections may be parallel connections 417, 419 between two subordinate terminals of like polarity. For example, a parallel connection 417 may be between two positive subordinate terminals 414 or a parallel connection 419 could be between two negative subordinate terminals 416. Other first electrical connections may be series connections 418 between terminals of opposite polarity. For example, a series connection 418 could be made between a positive subordinate terminal 414 and a negative subordinate terminal 416 or between a negative subordinate terminal 416 and a positive subordinate terminal 414.

A second electrical connection 420 connects the battery modules 412 in rows A and D to the master module 402. The four (4) modular batteries 412 in row A are connected via their positive subordinate terminals 414 to the positive master terminals 404 while the four (4) modular batteries in row D are connected via their negative subordinate terminals 416 to the negative master terminals 406.

The first electrical connection 417, 418, 419 may comprise an electrical connector that is removably attached to one subordinate terminal 414, 416 on a first battery module 412 and further removably attached to second subordinate terminal 414, 416 on an adjacent battery module 412. Similarly, a second electrical connection 420 may comprise an electrical connector that is removably attached to one subordinate terminal 414, 416 on a battery module 412 and further removably attached to a master terminal 404, 406 on the master module 402. The electrical connector may be selected according to the voltage and current of the system 400.

Any suitable number of battery modules may be connected in series (N) and any suitable number of battery modules may be connected in parallel (M) such that the total number of connected battery modules 412 in the overall battery pack is the product of N and M.

In the system 400, any suitable number of battery modules may be series-connected (N). For example, in FIGS. 4A and 4B, there are four series-connected battery modules between each negative master module 406 and a corresponding positive master module 404. In this example, the first battery module in each row is series-connected to the first battery module in an adjacent row, the second battery module in each row is series-connected to the second battery module an adjacent row, the third battery module in each row is series-connected to the third battery in an adjacent row, and the fourth battery in each row is series-connected to the fourth battery module in an adjacent row. Since there are four rows (A to D), N is equal to four in this configuration.

Additionally, the system 400 may include any suitable number of sets of battery modules that are parallel-connected relative to the master module 402 (M). For example, in FIGS. 4A and 4B, there are four negative master terminals 406 that correspond with four positive master terminals 404. Between each set of corresponding master terminals 404, 406, there is a set of battery modules that are connected in parallel relative to the battery modules between another set of corresponding master terminals. Since four sets of batteries are parallel-connected, M is equal to four in this configuration.

Battery modules may be connected in any suitable configuration such that the total number of connected battery modules 411 in the system 400 is the product of N and M. The total number of interconnected battery modules in the system 400 may be any suitable number. In some implementations, the system 100 may include 2 battery modules. In other implementations, the system 100 may include 10 battery modules, In further implementations, the system may include 20 battery modules. In yet further implementations, the system may include 100 battery modules.

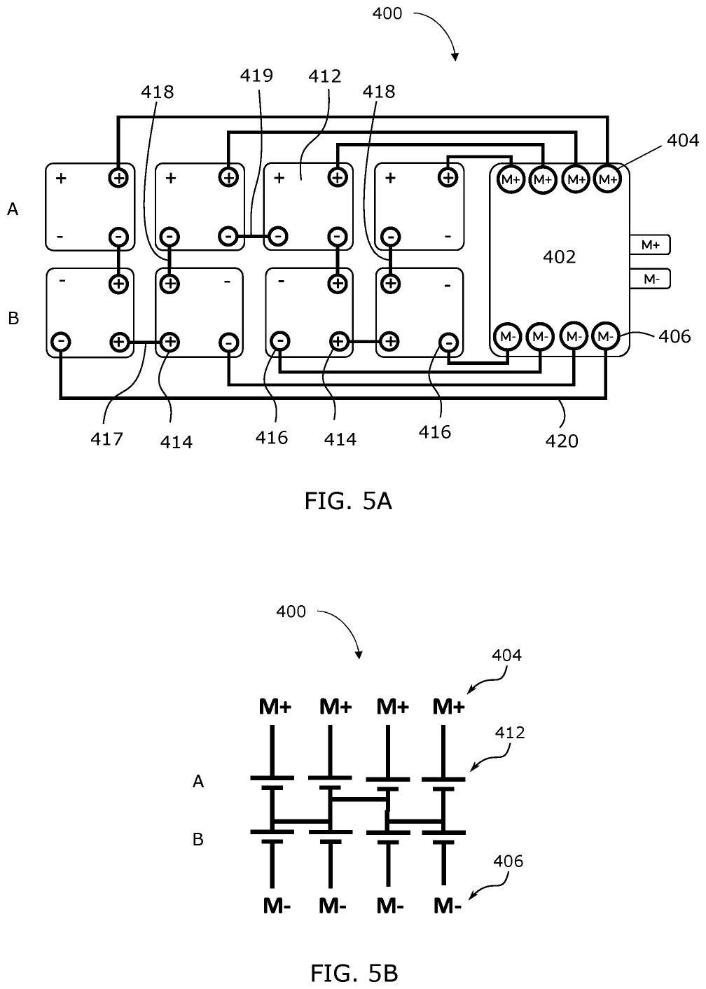

Turning to FIGS. 5A and 5B, schematic diagrams depict a two (2) series and four (4) parallel pack configuration of the claimed modular battery system 400. Since four sets of battery modules are parallel-connected relative to the master module 402, M is equal to four in this example. Since two battery modules are series-connected between each corresponding pair of master terminals, N is equal to 2 in this example.

A battery module that possesses a second electrical connection 420 from its positive subordinate terminal 414 to a positive master terminal 404 may also possess a second electrical connection 420 from its negative subordinate terminal 416 to a negative master terminal 406, in the specific case where the number of battery modules connected in series N in the pack is equal to one (1). Battery modules 412 connected to the master module 402 in this fashion may not be connected to an adjacent battery module 412 with either a parallel 417, 419 or a series connection 418.

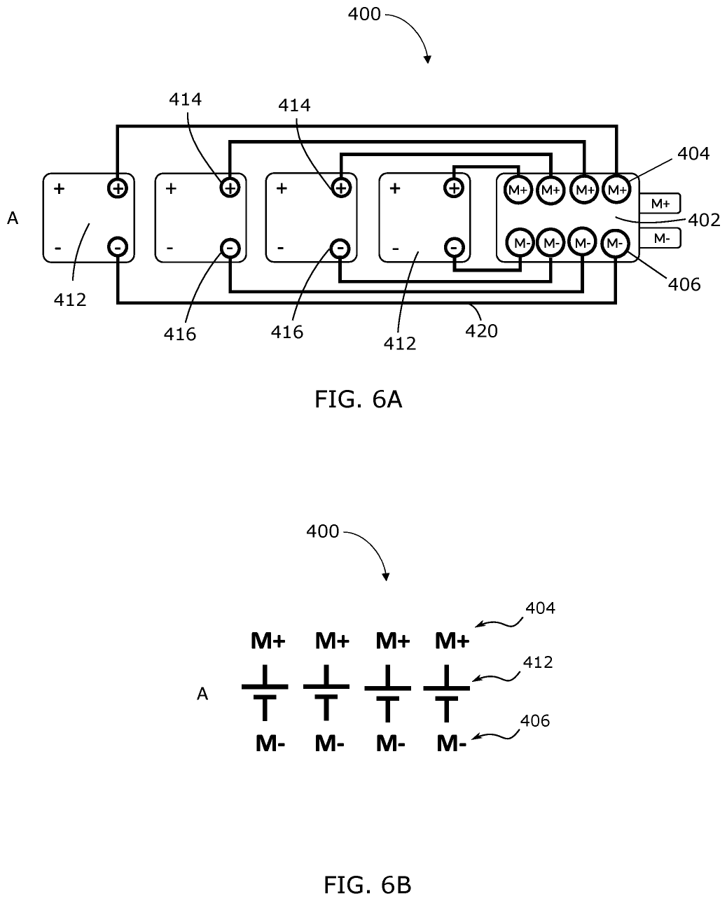

Turning to FIGS. 6A and 6B, a schematic diagram depicts a single series and four (4) parallel pack configuration of the claimed modular battery system 400. In this configuration, there are four battery modules 412 connected in parallel relative to the master module 402 and none of the battery modules 412 are connected in series. There are no first electrical connections between adjacent battery modules 412.

A specific pack electrical configuration—where the number of battery modules 412 connected in series, N, and the number of battery modules 412 connected in parallel, M, are designated to be specific values—may possess multiple electrical connection configurations.

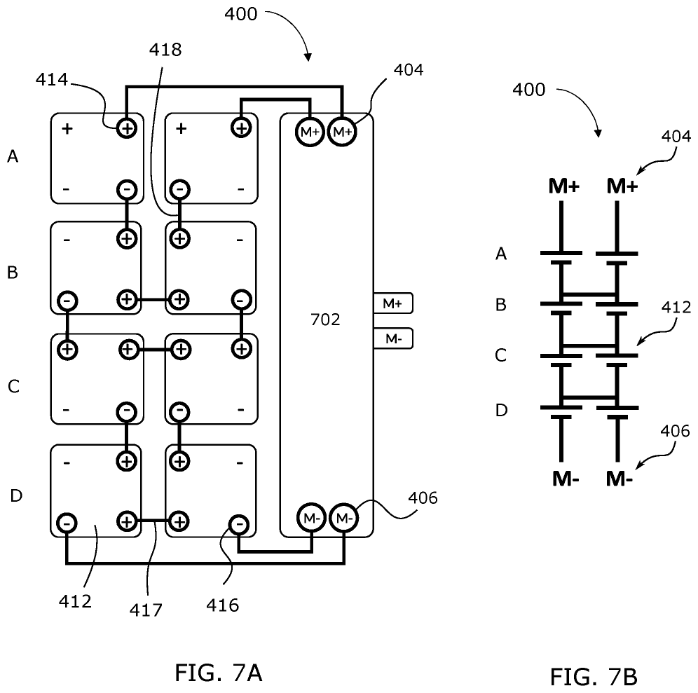

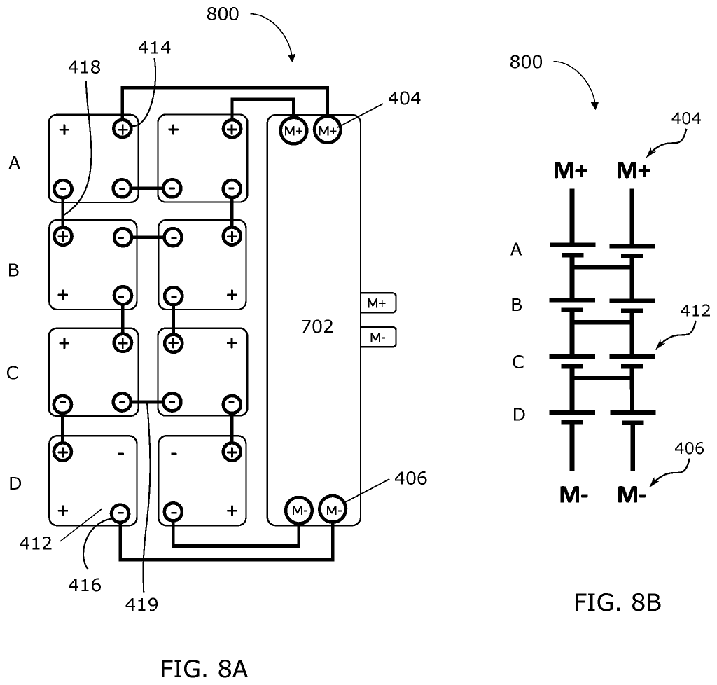

Turning to FIGS. 7A, 7B, 8A and 8B, schematic diagrams are shown depicting two configurations of the claimed modular battery system, both of which depict a four (4) series and two (2) parallel pack configuration. Since there are two sets of parallel connected battery modules (M is equal to 2), the master module 702 requires only two negative master terminals 406 and two positive master terminals 406. The configuration of FIGS. 7A and 7B includes three (3) parallel connections 417 between positive subordinate terminals 414 on three (3) pairs of adjacent battery modules 412 and zero parallel connections between negative subordinate terminals 416 on adjacent battery modules 412. The configuration of FIGS. 8A and 8B includes three (3) parallel connections 419 between negative subordinate terminals 416 on three pairs of adjacent battery modules 412 and zero (0) parallel connections between positive subordinate terminals 414 on adjacent battery modules 412. The configuration of FIGS. 7A and 7B and the configuration of FIGS. 8A and 8B both ensure the same number of parallel connections 417, 419 between battery modules in the pack through distinct electrical connection configurations, though both configurations are functionally equivalent.

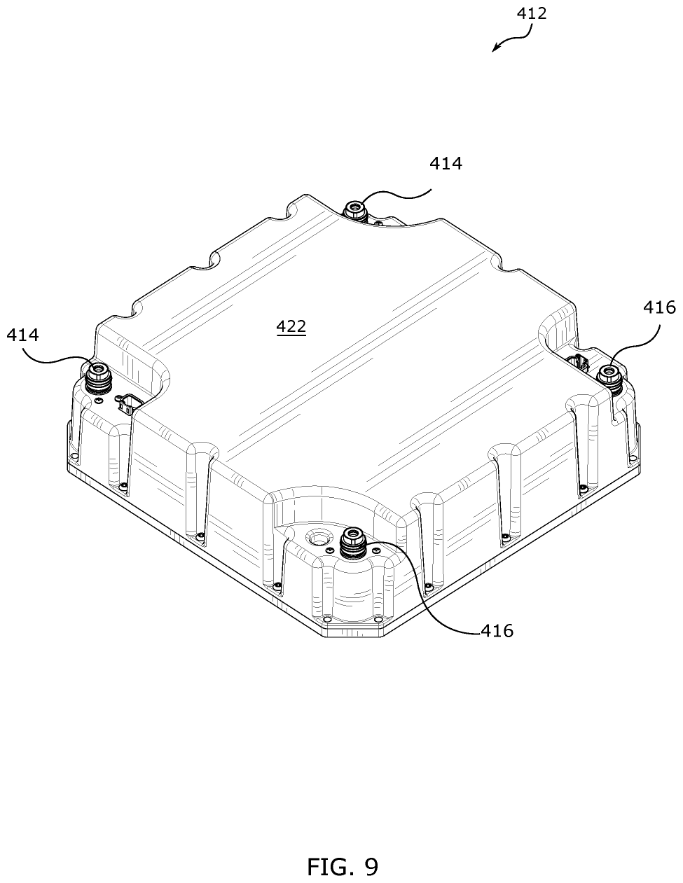

Turning now to FIG. 9, a single battery module 412 is depicted in perspective. The battery module 412 is depicted as having two positive subordinate terminals 414 and two negative subordinate terminals 414. The battery module 412 includes one or more battery cells. In some configurations, the battery module includes 10 battery cells. In other configurations, the battery module includes 80 battery cells. In further configurations, the battery module includes 168 battery cells. In yet further configurations, the battery module includes 300 battery cells.

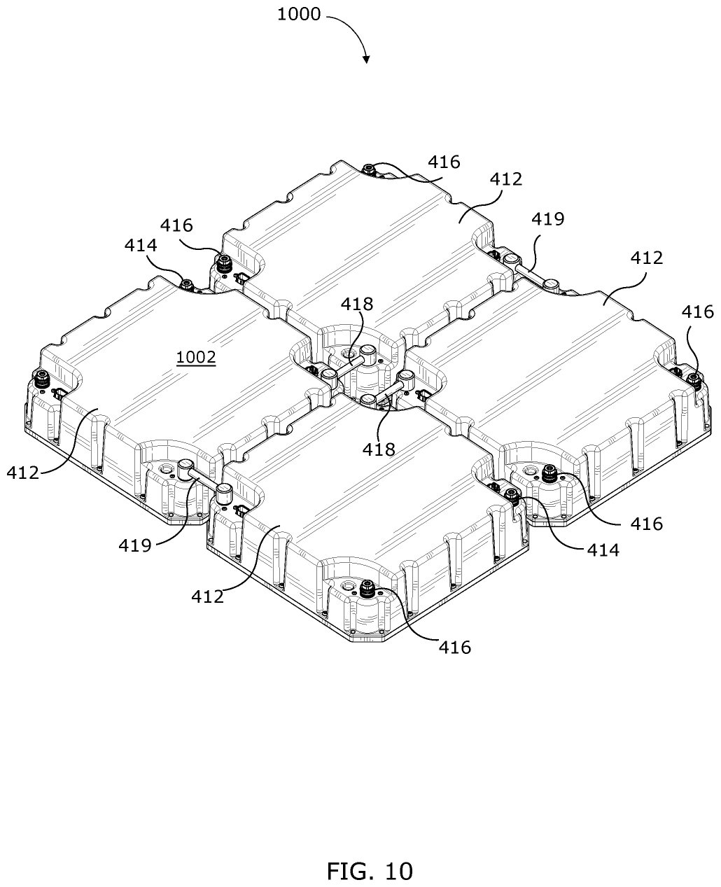

Turning now to FIG. 10, four interconnected battery modules 412 are generally shown at 1000. In this configuration, a plurality of connectors 419 are removably attached to the subordinate terminals 414, 416 of adjacent battery modules. The subordinate terminals 414, 416 may be positioned to reduce the distance between subordinate terminals on adjacent battery modules 412. The battery modules 412 may be substantially square in shape as depicted, however the battery module is not particularly limited in shape or form.

The battery module may have a flat upper surface 1002 and flat lower surface (not shown). This design may enable the battery modules 412 to be stacked vertically. In the configuration shown, connectors 419 connect adjacent battery modules 412 that are substantially aligned on a horizontal plane, however, it is also contemplated that connectors may connect neighboring battery modules 412 that are stacked vertically.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well known structures may be shown in block diagram form in order not to obscure the understanding. For example, specific details are not provided as to whether elements of the embodiments described herein are implemented as a software routine, hardware circuit, firmware, or a combination thereof.

We claim:

1. A modular battery system comprising:
a master module comprising at least two master terminals; and
a plurality of interconnected battery modules, the interconnected battery modules comprising at least two subordinate negative terminals and at least two subordinate positive terminals;
wherein respective subordinate terminals of two battery modules of the interconnected battery modules are electrically connected by a first electrical connection;
wherein the at least two subordinate terminals are electrically connected to the at least two master terminals by a second electrical connection;
wherein one or both of the first electrical connection and the second electrical connection includes a parallel connection between two terminals of like polarity.

2. The modular battery system of claim 1 wherein one or both of the first electrical connection and the second electrical connection further includes a series connection between two terminals of opposite polarity.

3. The modular battery system of claim 2:
wherein the plurality of interconnected battery modules includes a number of interconnected battery modules,
wherein the number of interconnected battery modules includes a number of battery modules connected in series and a number of battery modules connected in parallel;
wherein the number of interconnected battery modules is the product of the number of battery modules connected in series and the number of battery modules connected in parallel.

4. The modular battery system of claim 1 wherein the first electrical connection is between two adjacent battery modules.

5. The modular battery system of claim 1, the master module further comprising at least two master positive terminals and at least two master negative terminals.

6. The modular battery system of claim 5, the master module further comprising four master positive terminals and four master negative terminals.

7. The modular battery system of claim 1:
wherein the first electrical connection includes an electrical connector;
wherein the electrical connector is removably attached to a first subordinate terminal of a first battery module of the plurality of interconnected battery modules; and
wherein the electrical connector is further removably attached to a second subordinate terminal of a second battery module of the plurality of interconnected battery modules.

8. The modular battery system of claim 1:
wherein the second electrical connection includes an electrical connector;
wherein the electrical connector is removably attached to a first subordinate terminal of a first battery module of the plurality of interconnected battery modules; and
wherein the electrical connector is further removably attached to one of the at least two master terminals.

9. The modular battery system of claim 1 wherein the plurality of interconnected battery modules is configured to be stacked.

10. The modular battery system of claim 1 wherein the interconnected battery modules are square.

11. A method of connecting batteries in a modular battery system, the modular battery system comprising:
a master module comprising at least two master terminals; and
a plurality of interconnected battery modules, the interconnected battery modules comprising at least two subordinate negative terminals and at least two subordinate positive terminals;
the method comprising:
electrically connecting respective subordinate terminals of two battery modules of the plurality of interconnected battery modules, such that the respective subordinate terminals are connected by a first electrical connection; and
electrically connecting the at least two subordinate terminals to the at least two master terminals, such that the at least two subordinate terminals are connected to the at least two master terminals by a second electrical connection;
wherein one or both of the first electrical connection and the second electrical connection includes a parallel connection between two terminals of like polarity.

12. The method of claim 11 wherein one or both of the first electrical connection and the second electrical connection further includes a series connection between two terminals of opposite polarity.

13. The method of claim 12:
wherein the plurality of interconnected battery modules includes a number of interconnected battery modules;
wherein the number of interconnected battery modules includes a number of battery modules connected in series and a number of battery modules connected in parallel;
wherein the number of interconnected battery modules is the product of the number of battery modules connected in series and the number of battery modules connected in parallel.

14. The method of claim 11 further comprising electrically connecting respective subordinate terminals of two adjacent battery modules of the plurality of interconnected battery modules, such that the respective subordinate terminals are connected by a first electrical connection.

15. The method of claim 11 wherein the master module further comprises at least two master positive terminals and at least two master negative terminals.

16. The method of claim 14 wherein the master module further comprises four master positive terminals and four master negative terminals.

17. The method of claim 11 wherein the first electrical connection includes an electrical connector, the method further comprising:
removably attaching the electrical connector to a first subordinate terminal of a first battery module of the plurality of interconnected battery modules; and
removably attaching the electrical connector to a second subordinate terminal of a second battery module of the plurality of interconnected battery modules.

18. The method of claim 11 wherein the second electrical connection includes an electrical connector, the method further comprising:
removably attaching the electrical connector to a first subordinate terminal of a first battery module of the plurality of interconnected battery modules; and
removably attaching the electrical connector to one of the at least two master terminals.

19. The method of claim 11 further comprising stacking the plurality of interconnected battery modules.

20. The method of claim 11 wherein the interconnected battery modules are square.
